(19) United States
(12) Patent Application Publication
(10) Pub. No.: US 2025/0243353 A1
(43) Pub. Date: Jul. 31, 2025

(54) MASTER-BATCH COMPOSITION FOR IMPROVED PLASTIC PALLET STIFFNESS AND REDUCED PRODUCT WEIGHT

(71) Applicant: National Industrialization Company (TASNEE), Riyadt (SA)

(72) Inventors: Mohammed Ali Ghanchi, Jubail (SA); Jayanta Bera, Jubail (SA); Mukesh K. Yadav, Jubail (SA); Hamdan Al Shehri, Jubail (SA)

(21) Appl. No.: 18/422,764

(22) Filed: Jan. 25, 2024

(51) Int. Cl. C08L 23/12; C08K 3/34

(52) U.S. Cl. CPC C08L 23/12; C08K 3/34; C08L 2205/025; C08L 2207/20; C08L 2310/00

(57) ABSTRACT

Disclosed herein are methods and compositions for manufacturing light weight plastic pallets. The light weight plastic pallets may be formed of a polymer blend comprising polypropylene and 5% to 20% of a masterbatch comprising polypropylene homopolymer and talc. One embodiment of the polymer blend comprises 10% masterbatch containing 60% talc into recycled polypropylene which showed a 34% improvement in the flexural modulus.

### BACKGROUND OF THE DISCLOSURE

The following disclosure generally relates to a polymer composition and manufacture and, more specifically, to a polypropylene-based formulation having increased stiffness and reduced weight.

A number of wooden products have been and are being replaced by similar plastic products. For example, wooden pallets have a number of issues limiting their performance which could be potentially improved by using plastics. Common issues include pest infestation, cracking, and decomposition, requiring the wooden pallets to be continuously treated with antibacterial and insect repellent chemicals. Further, the weight of the wood is a disadvantage for shipping.

For many years, it has been an aim to replace wooden pallets with plastic ones. In comparison to wooden pallets, plastic pallets provide several benefits, including increased durability, less weight, more uniform dimensions, enhanced cleanliness, water resistance, and the ability to be recycled. However, wood is more rigid than the conventional plastic used to build pallets. To make up for the lower rigidity and stiffness, plastic pallets require more material, thus adding to their weight. While numerous plastic pallet designs have already been tried, the ones that can come close to the strength of wood are, to date, too expensive or do not have the right strength characteristics. Thus, it would be desirable to provide a plastic pallet material which is both light, stiff, strong, and inexpensive.

### SUMMARY OF THE DISCLOSURE

A polymer blend comprises polypropylene and a masterbatch made of a polypropylene homopolymer and talc. The resulting polymer blend has increased stiffness and reduced weight compared to polypropylene alone. In one embodiment, polymer blend comprises about 5 wt % to about 20 wt % masterbatch. In another embodiment, the talc is present in the masterbatch in an amount ranging from about 50 wt % to about 65 wt % of the masterbatch.

In yet another embodiment, the polymer blend is used to make a light weight plastic pallet weighing about 10 kg or less, and having an ultimate load bearing capability in a range of about 2900 kg to about 3600 kg at a deflection of 58 mm.

### BRIEF DESCRIPTION OF THE DRAWINGS

The accompanying drawings, which are incorporated in and constitute a part of this specification, illustrate one or more implementations or testing equipment described herein and, together with the description, explain these implementations. Not every component may be labeled in every drawing. In the drawings:

FIG. 1 is a photograph of the test arrangement used to determine stiffness of an embodiment of the presently disclosed plastic pallet.

### DETAILED DESCRIPTION OF EXEMPLARY EMBODIMENTS

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the present disclosure have been described in terms of preferred embodiments, it will be apparent to those skilled in the art that variations may be applied to the articles and/or methods and in the steps or in the sequence of steps of the method described herein without departing from the concept and scope of the present disclosure. All such similar substitutes and modifications apparent to those skilled in the art are deemed to be within the scope and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

A plastic pallet design was developed by TASNEE Research Center which weighed about 9.5 kg and was intended to exhibit dynamic and static loads of 1375 kg and 2750 kg, respectively. This 9.5 kg plastic pallet design was a pioneering achievement considering the “load-to-weight” ratio. This ˜9.5 kg plastic pallet could handle static and dynamic loads similar to that of a wooden pallet which weighs about 18-23 kg. Further, available plastic pallets on the market for the same application were about 53% heavier.

However, during field trials stiffness issues were observed with the new plastic pallet design due to the natural flex phenomenon of the plastic after long storage durations. This stiffness concern was mitigated on existing plastic pallets by increasing the product weight and thus making it heavier and bulkier for the required application. However, it was desired to improve the product stiffness with minimal increase in product weight. Thus, additional research was performed to determine if it was possible to improve product stiffness via material modification. A novel master-batch was discovered which could be added to a recycled polypropylene (PP) base resin to improve the pallet performance and achieve the desired stiffness targets.

Similar attempts to improve product stiffness are disclosed in, for example, Canadian Patent No. 2946800 using specific polypropylene-polyethylene blends. U.S. Pat. No. 9,200,151 discloses a base resin of high crystalline polypropylene and/or a propylene-ethylene copolymer with additional elastomers, whiskers, siloxane compounds, etc. that apparently has high stiffness and can be formed as a thin film. JP 6470483B2 and KR200371135Y1 describe similar attempts to improve material properties by adding other materials.

Recycled polypropylene (RPP) material was used to produce a light weight plastic pallet (LWPP). RPP material was produced by recycling used battery cases which were made of polypropylene impact copolymer. Melt flow rate (MFR) and density of RPP material was approximately 8 g/10 min (at 230° C./2.16 Kg) and 0.9173 g/cm³, respectively.

LWPP made from neat RPP material was found to have lower stiffness which resulted in a lower ultimate load on the pallet. Ultimate load is measured as the maximum load obtained at the break point of the pallet. Break-point is defined as either pallet breakage or the maximum ultimate load achieved at 58 mm deflection at a fork entry gap of 116 mm.

While static and dynamic load targets for LWPP are 2750 kg and 1375 kg, respectively, an ultimate load bearing capability of 3000 Kg at a deflection of 58 mm was our targeted specification for LWPP. Average ultimate load of LWPP made of neat RPP was 1740 Kg which was much lower than minimum requirements for the pallet. A novel masterbatch was developed which was added in RPP to improve the stiffness of the material. Increased stiffness of raw material of LWPP improved the ultimate load of LWPP to the target level.

Mineral filler talc was selected as a reinforcing agent in the masterbatch. Addition of talc-filled masterbatch with RPP material in certain percentages enhanced the stiffness of the product but the overall density of the product was also increased. Product weight was increased because the masterbatch density was higher than that for RPP. Since our main aim was to improve ultimate load bearing capability of LWPP with limited increase in LWPP product weight, as well as cost effectiveness, an optimum level of talc was selected to balance the density increase and stiffness improvement.

Selection of suitable talc reinforcement was done targeting minimum percentage addition level of the masterbatch in RPP to achieve the target properties in LWPP. A specific talc grade containing natural hydrated magnesium silicate was selected as reinforcement in the masterbatch. The particle size distribution, D98 and D50, of the selected talc grade were 15 μm and 4.5 μm, respectively as per Sieve-graph 5100 analysis.

Melt flow index (MFR) of the masterbatch was selected for better flow and dispersion of talc in injection molded plastic pallet product. Suitable homo-PP with a higher MFR and better stiffness was selected as a base resin for the masterbatch. Specifically, 25 MFR (at 230° C./2.16 Kg) homo-PP grade produced by TASNEE was selected as base resin for the masterbatch.

A higher loading of talc was selected to maximize the stiffness improvement and lower the cost. Good dispersion of filler was one of the factors for the selection. A 60% talc loading was selected for ease of processability and better dispersion of masterbatch in RPP during injection molding process.

A primary antioxidant which is hindered phenols act as free-radical scavengers and prevent or interrupt oxidation reactions. Secondary antioxidants, phosphite which is hydroperoxide decomposers, act to convert hydroperoxides into nonradical and thermally stable products. Hence, combination of primary and secondary antioxidants was used to get synergistic stabilization effects. Primary antioxidant Anox 18 and secondary antioxidant Alkanox 240 from GSI, KSA were selected for use in the masterbatch, but other similar antioxidants could have been selected.

Calcium stearate DW from Faci Asia Pacific Pte Ltd was used as an acid scavenger and process aid for the masterbatch. Licowax C from Clariant was used as a lubricant for better flow of polymer, and as a dispersing agent to improve dispersion of talc in polymer matrix of the masterbatch.

Formulation of the masterbatch is provided in Table 1 below:

TABLE 1
Formulations of Masterbatch

| | | | Target |
|---|---|---|---|
| No. | Raw Material | Manufacturer | wt % |
| 1 | 25 MFR PP-Homopolymer | TASNEE, KSA | 39.3 |
| | TASNEE PP H2250 | | |
| 2 | Talc EGSL 15 (15 μm | Golcha, India | 60 |
| | top cut) | | |
| 3 | Anox 18 | GSI, KSA | 0.05 |
| 4 | Alkanox 240 | GSI, KSA | 0.05 |
| 5 | Calcium Stearate | Faci Asia Pacific | 0.3 |
| | DW | Pte Ltd | |
| 6 | Licowax C | Clariant Europe | 0.3 |

The formulation shown in Table 1 was compounded in a Coperion extruder ZSK26 keeping a melt temperature of 225° C. Uniform strand cut pellets of the masterbatch were produced.

The ash content of the masterbatch was tested at 625° C. for 20 minutes in a muffle furnace and was found to be 60±1 percentage. The melt flow rate (MFR) and density of the masterbatch measured to be 15 g/10 min (at 230° C./2.16 Kg) and 1.45 g/cm³.

### EXAMPLES

Compounded masterbatch described above was added to RPP in different ratios or percentages and test specimens were prepared by injection molding for measurement of flexural modulus and density. Molded specimens containing 5%, 10%, 15% and 20% by weight of masterbatch (MB) were mixed with RPP uniformly for injection molding of the specimen preparations. Physical and mechanical properties of RPP containing different percentage of masterbatch namely 0%, 5%, 10%, 15% and 20% are shown in Table 2 below. It should be noted that addition of 10% masterbatch in RPP resulted in a 33.9% improvement in flexural modulus of the RPP.

TABLE 2
Properties of RPP with different percentages of Masterbatch

| | | ISO | | 100% RPP | 95% RPP | 90% RPP | 85% RPP | 80% RPP |
|---|---|---|---|---|---|---|---|---|
| No. | Test | Method | Unit | 0% MB | 5% MB | 10% MB | 15% MB | 20% MB |
| 1 | Density | 1183 | g/cc | 0.9173 ± | 0.9375 ± | 0.9571 ± | 0.9698 ± | 1.0235 ± |
| | | | | 0.0009 | 0.0003 | 0.0001 | 0.0011 | 0.0005 |
| 2 | Tens. Strength | 527-2 | MPa | 24 ± | 25 ± | 25 ± | 25 ± | 24 ± |
| | @ Yield | | | 1 | 0 | 0 | 0 | 0 |
| 3 | Tens. Mod. | 527-2 | MPa | 1240 ± | 1420 ± | 1600 ± | 1770 ± | 1770 ± |
| | (Chord) | | | 37 | 37 | 59 | 31 | 39 |
| 4 | Flexural Mod. | 178 | MPa | 1180 ± | 1390 ± | 1580 ± | 1750 ± | 1940 ± |
| | (Chord) | | | 28 | 45 | 35 | 33 | 39 |
| | @23° C. | | | | | | | |
| 5 | Izod Impact | 180/1A | kJ/m² | 7.7 ± | 7.20 ± | 6.80 ± | 6.10 ± | 5.80 ± |
| | Strength | | | 0.20 | 0.40 | 0.40 | 0.30 | 0.20 |
| | (Notched) | | | | | | | |
| | @23° C. | | | | | | | |

Pallets were produced in injection molding machines using recycled polypropylene (RPP) mixed with 5% and 10% of masterbatch to determine which percentage is suitable for the target improvement in ultimate load and stiffness of the pallets. Smooth injection molding processability of RPP with 5% and 10% of masterbatch was found.

### Results

Produced plastic pallet samples of LWPP were tested after 72 hours conditioning time to determine the ultimate load bearing capability of the pallets. An ultimate load bearing capability of 3000 Kg at target deflection specification of 58 mm was desired for the existing plastic pallet design. Addition of 10% masterbatch in RPP showed 33.9% improvement in flexural modulus compared to Recycled Polypropylene alone.

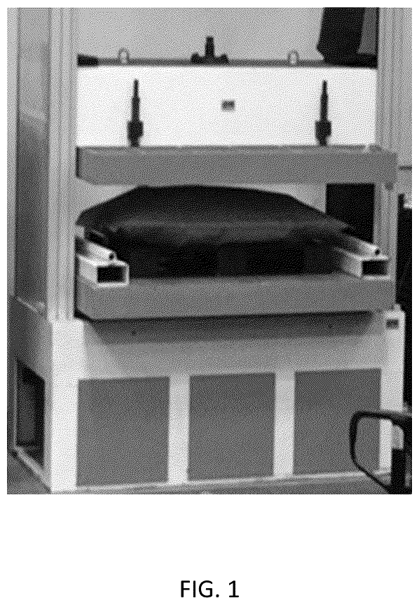

Plastic pallet improvement in stiffness was done via compression machine using air bag. The pallet was placed between compression machine platens and an air bag was placed on top of pallet. A load was applied until the predetermined deflection of 58 mm was reached. For 58 mm deflection, the required load was recorded as the ultimate load. A picture of the test arrangement is shown in FIG. 1.

Ultimate load of LWPP at average deflection of 58 mm are shown in Table 3 below.

TABLE 3
Properties of LWPP made from RPP with
different percentages of Masterbatch

| | Avg. Ultimate | Avg. Deflection | Avg. Weight |
|---|---|---|---|
| Materials | Load (kg) | (mm) | (kg) |
| 100% RPP | 1740 | 58 | 9.3 |
| 95% RPP + 5% MB | 2950 | 58 | 9.39 |
| 90% RPP + 10% MB | 3550 | 58 | 9.62 |

The ultimate load of plastic pallet produced from 100% RPP, 95% RPP/5% masterbatch and 90% RPP/10% masterbatch was found to be 1740, 2950 and 3550 kg, respectively. LWPP produced with 90% RPP/10% masterbatch complied with the requirement of ultimate load specification of 3000 kg at a deflection of 58 mm.

The target specification of ultimate load was achieved while the weight of plastic pallet was increased from 9.3 Kg to 9.62 Kg due to change in material from 100% RPP to 90% RPP+10% masterbatch.

Finally, LWPP produced with 90% RPP+10% masterbatch passed field tests of lifting and stacking.

Thus, in accordance with the presently disclosure, there has been provided a method and composition for manufacturing light weight plastic pallets as described above. While the foregoing written description of the disclosure enables one of ordinary skill to make and use what is considered presently to be the best mode thereof, those of ordinary skill will understand and appreciate the existence of variations, combinations, and equivalents of the specific exemplary embodiments and methods herein. The disclosure should therefore not be limited by the above-described embodiments and methods, but by all embodiments and methods within the scope and spirit of the disclosure as claimed.

What is claimed is:

1. A polymer blend, comprising:
polypropylene; and
a masterbatch, wherein the masterbatch comprises a polypropylene homopolymer and talc.

2. The polymer blend of claim 1, wherein the polypropylene comprises recycled polypropylene.

3. The polymer blend of claim 1, comprising about 5 wt % to about 20 wt % masterbatch.

4. The polymer blend of claim 1, wherein the talc is present in the masterbatch in an amount ranging from about 50 wt % to about 65 wt % of the masterbatch.

5. The polymer blend of claim 1, wherein the masterbatch further comprises an antioxidant, calcium stearate, and a lubricant.

6. A light weight pallet, comprising:
a body formed of a polymer blend, comprising:
polypropylene; and
a masterbatch, wherein the masterbatch comprises a polypropylene homopolymer and talc.

7. The light weight pallet of claim 6, wherein the polypropylene of the polymer blend comprises recycled polypropylene.

8. The light weight pallet of claim 6, wherein the polymer blend comprises masterbatch in a range between about 5 wt % to about 20 wt %.

9. The light weight pallet of claim 6, wherein the talc is present in the masterbatch in an amount ranging from about 50 wt % to about 65 wt % of the masterbatch.

10. The light weight pallet of claim 6, wherein the masterbatch further comprises an antioxidant, calcium stearate, and a lubricant.

11. The light weight pallet of claim 6, wherein the light weight pallet has a weight of about 10 kg or less, and an ultimate load bearing capability in a range of about 2900 kg to about 3600 kg at a deflection of 58 mm.

12. The light weight pallet of claim 6, wherein the body of the light weight pallet is formed using injection molding techniques.
